(19) United States
(12) Patent Application Publication
(10) Pub. No.: US 2022/0187906 A1
(43) Pub. Date: Jun. 16, 2022

(54) OBJECT AVOIDANCE USING EAR-WORN DEVICES AND IMAGE SENSORS

(71) Applicant: Starkey Laboratories, Inc., Eden Prairie, MN (US)

(72) Inventors: Sandra Jobes, St. Louis Park, MN (US); Karrie LaRae Recker, Eden Prairie, MN (US)

(21) Appl. No.: 17/544,721

(22) Filed: Dec. 7, 2021

Related U.S. Application Data
(60) Provisional application No. 63/126,344, filed on Dec. 16, 2020.

(51) Int. Cl. G06F 3/01; H04B 1/3827; H04R 25/02

(52) U.S. Cl. CPC G06F 3/012; H04B 2001/3866; H04R 25/02; H04B 1/385

(57) ABSTRACT

A system may include one or more image sensors, an ear worn device, and a controller. The one or more image sensors may be configured to sense optical information of an environment and produce image data indicative of the sensed optical information. The ear-worn device may include a housing wearable by a user, an acoustic transducer including at least one driver to generate sound, and a controller comprising one or more processors. The controller may be operatively coupled to the image sensor and the ear-worn device. The controller may be configured to receive the image data, determine a field of attention of the user using the image data, detect an object outside of the field of attention using the image data, determine whether to alert the user of the detected object, and provide an alert indicative of the detected object, if it is determined to alert the user.

### RELATED APPLICATIONS

This application claims the benefit of U.S. Provisional Application No. 63/126,344, filed Dec. 16, 2020, the content of which is hereby incorporated by reference.

### TECHNICAL FIELD

This application relates generally to ear-worn devices, including hearing aids, personal amplification devices, hearables, wireless headphones, wearable cameras, and physiologic, or position/motion sensing devices.

### BACKGROUND

Obstacle detection systems may detect and alert people to obstacles. Such systems may be used by people who are visually impaired or who are operating heavy or expensive equipment. Although people with unimpaired vision may also benefit from such systems, in many instances alerting someone with normal vision to every obstacle that they may encounter may be considered a nuisance because in most cases they may already be aware of the obstacle and are planning to avoiding.

### SUMMARY

Embodiments are directed to a system, including one or more image sensors and an ear-worn device. The one or more image sensors may be configured to sense optical information of an environment and produce image data indicative of the sensed optical information. The ear-worn device may include a housing wearable by a user, an acoustic transducer to generate sound, and a controller. The controller may include one or more processors and may be operatively coupled to the image sensor and the ear-worn device. The controller may be configured to receive the image data and determine a field of attention of the user using the image data. The controller may further be configured to detect an object outside of the field of attention using the image data and determine whether to alert the user of the detected object. The controller may further be configured to provide an alert indicative of the detected object if it is determined to alert the user.

Embodiments are directed to a method that may include receiving image data from one or more image sensors using a controller of an ear-worn device; determining a field of attention of the user using the image data using the controller; detecting an object outside of the field of attention using the image data using the controller; determine whether to alert the user of the detected object using the controller; and providing an alert indicative of the detected object to a user wearing the ear-worn device, if it is determined to alert the user using the controller.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings wherein:

FIG. 1A is a system block diagram of an ear-worn electronic ear-worn device configured for use in, on, or about an ear of a user in accordance with any of the embodiments disclosed herein;

FIG. 1B is a system block diagram of two ear-worn electronic ear-worn devices configured for use in, on, or about left and right ears of a user in accordance with any of the embodiments disclosed herein;

FIG. 2 is a system block diagram of a system in accordance with any of the embodiments disclosed herein;

FIG. 3 is a flow diagram of a method in accordance with any of the embodiments disclosed herein; and

FIG. 4 is a flow diagram of another method in accordance with any of the embodiments disclosed herein;

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Embodiments of the disclosure are directed to systems and methods using an image sensor in conjunction with an ear-worn device to determine whether to alert a user to an object outside of the user's vision or field of attention. Embodiments of the disclosure are directed to systems and methods to identify objects located outside of a user's field of attention and determine whether to alert the user of the detected object. People with unimpaired vision (e.g., having 20/20 vision and lacking visual impairments such as, for example, astigmatism, amblyopia, aniridia, etc.) may not need to be made aware of objects in their environment at all times. Instead, such persons may only need to be made aware of objects in their environment when their attention is engaged elsewhere. In most instances, a person may already be aware of objects in their environment and plan to avoid such objects. Technologies may exist that can detect and alert a user to objects in their environment, however, such technologies may not discriminate between objects that the user is likely aware of and objects that the user is likely not aware of. If the user's field of attention can be determined or is known, it can be determined whether to alert the user of an object in their environment. Accordingly, users can be alerted to objects in their environment that may result in collision, injury, or fall that they may be unaware of without alerting users to every object. As used herein, the terms “object” and “obstacle” may refer to anything that a user could collide with and may include any living creature or nonliving object, whether stationary or moving.

Such systems and methods of object detection may most often be used by people who are visually impaired or who are operating heavy or expensive equipment. However, people with unimpaired vision may also benefit from the systems and methods described herein. For example, a person walking down the street may want to know about objects they may trip over that they have not noticed because such person is texting. In many instances, alerting a person with unimpaired vision to every object that they may encounter could be a nuisance because, in many cases, they may already be aware of many objects in their environment and plan to avoid such objects. Systems and methods as described herein may provide users with the benefit of being made aware of potential objects that may have the potential to cause a collision, injury, or fall and at the same time not alerting users of objects that they may already be aware of.

In one or more embodiments, determining whether to alert a user may be based at least in part on the user's field of attention. As used herein, the term “field of attention” may refer to a range around a user that the user may be focused on or be aware of. This range may include some or all of the user's field of vision. Such range may also include portions of the environment that were recently within the user's field of vision, e.g., within the user's field of vision less than or equal to 5 seconds ago, less than or equal to 4 seconds ago, less than or equal to 3 seconds ago, less than or equal to 2 seconds ago, less than or equal to 1 seconds ago, etc. Objects outside the user's field of vision that are making noise may be included in the user's field of attention.

In one embodiment, determining whether to alert a user may include comparing the position of the user's head or the direction of the user's eye gaze with the direction that the user is moving. In other words, the position of the user's head or the direction of the user's eye gaze may be used to determine the user's field of attention. If the user is not facing or looking in the same direction that they are moving, then the person may be alerted to an object outside the user's field of attention. If the user is facing or looking in the same direction that the user is moving, or if the user looks in a different direction for a brief amount of time (e.g., less than or equal to 5 seconds ago, less than or equal to 4 seconds ago, less than or equal to 3 seconds ago, less than or equal to 2 seconds ago, less than or equal to 1 seconds ago, etc.), then the user may not be alerted to an object outside their field of view. In this manner, systems and methods as described herein may infer whether a collision, injury, or fall is likely and selectively alert the individual regarding such objects.

Additional details may be incorporated into the decision whether or not to alert the user to an object, including, for example, the duration of the user's diverted attention, whether the object produces noise, ear-worn device information, environmental conditions, location parameters, movement parameters, physiological parameters, sound data, time-based parameters, user information, etc.

Ear-worn device information may include, for example, information about the device style, onboard hardware and features, receiver matrix information, earmold information (e.g., style, material, venting, etc.), information about the hearing abilities of the wearer, real-time data collected or generated by the hearing aids, analysis incoming acoustic signals, current ear-worn device parameters (e.g., gains, compression ratios, outputs, etc.), active features (e.g., noise reduction, frequency translation, etc.), microphone mode (e.g., omnidirectional, directional, etc.), whether the ear-worn device is currently streaming media, whether the ear-worn device is currently in a telecoil mode, whether the microphones of the ear-worn devices are turned off or at a reduced level, sensor information, etc.

Environmental conditions may include, for example, the speed at which the user is moving, the speed at which objects in the user's environment are moving, the size of the object, the estimated weight of the object, the user's familiarity with the environment, the topography (e.g., slope, evenness, etc.) of the terrain of the environment, the lighting conditions, the weather, etc.

Location parameters may include, for example, a user's current location, a user's location history, a topography of the surrounding environment, etc.

Movement parameters may include, for example, the speed of the user's movements, the direction of the user's movements, the user's gaze direction, the topography of the terrain, the user's gait, etc.

Physiological parameters may include, for example, heart rate, temperature, steps, head movement, body movement, skin conductance, user engagement, etc.

Sound data may include, for example, overall or frequency-specific sound levels, signal to noise rations (SNRs), noise data, classified environment(s) (e.g., speech, music, machine noise, wind, etc.), analysis of the user's speech for key words or impairment, etc.

Time-based parameters may include, for example, the date, time of day, etc.

User information may include, for example, information about the user's physical abilities (e.g., visuality acuity, field of vision, type and degree of hearing loss, mobility, gait, a general clumsiness level of the user, etc.), the user's cognitive abilities, the user's collision history, health conditions, familiarity with a space, demographics (e.g., age, gender, etc.), ear-worn device use patterns, preferences for the conditions under which the user would like to receive alerts, etc.

Additionally, some, if not all, of the items listed above may be customized by the user to increase or decrease the likelihood that the user receives an alert. For example, if the user knows that they do poorly in low-lit conditions or on uneven terrain, the user may increase the likelihood of receiving an alert in such situations. Further, for example, the user may desire to be made more aware of objects as the user or the object is moving faster or as the objects are farther from the user's field of attention and the user can adjust the likelihood of an alert in such situations.

Additionally, systems and methods for determining whether to alert the user to an object may offer learning features. For example, data from image sensors, ear-worn devices, smartphones, etc. may be stored over time and when a collision occurs (e.g., detected by image sensors, movement sensors, computing devices, etc.), the collision may be recorded along with recorded environmental and user information and analyzed to determine the series of circumstances or events that lead to the collision. Such information may be used to improve how the systems and methods described herein determine whether to alert the users of objects both for individual users or groups of users.

The systems and methods described herein to determine whether to alert a user of objects may be useful in many different scenarios or examples. In one example, a user may be walking with another person, looking at the person and not paying attention to objects in front of them. In another example, a user may be engaged with a computing device (e.g., texting, emailing, surfing the Internet, etc.) and not paying attention to where they are going or paying attention to objects that may enter their path. In another example, the user may be in a low-lit room and a pet may be in an unexpected spot on the floor or stairs. In another example, a user may walk across the road while listening to music streamed from the user's smartphone and may fail to notice the biker who is about to cross the user's path. In each of these examples the systems and methods described herein may determine whether to alert the user to objects that they may be unaware of based at least on a user's field of attention.

In addition to the user's field of attention, determining whether to alert the user to an object may further involve using the direction and speed the user is moving or the speed and direction objects in the environment are moving, or both. Such information can be determined in the following ways:
The user's field of attention may be determined using one or more of the following:
   positional sensors such as inertial measurement units (IMUs), in an ear-worn device may indicate the direction that the user is looking such as, for example, to the front, side, up, down, or some combination thereof;
      IMUs may include, for example, accelerometers, gyroscopes, magnometers, etc.;
   a camera on a computing device may be used to determine whether the user's field of attention is directed toward the computing device's screen;
   image data provided by the image sensors may be used to determine the user's field of attention; and
   eye movement-related eardrum oscillations (EMRE0s) may be used to determine gaze direction and the field of attention of the user; and
      EMREOs may be measured using a microphone in the ear canal, where the microphone is operatively coupled to the ear-worn device.
The direction and speed that the user is moving may be detected using one or more of the following:
   ear-worn device
      IMUs
   computing device;
      IMU;
      Global Position System (GPS);
      image data captured by one or more image sensors
   positional sensors;
      image data captured by one or more image sensors;
      IMU; and
      GPS.
Objects entering the user's path may be determined using one or more of the following:
   image data captured by the image sensors;
   image sensors or other sensors of the computing device; and
   sounds made by the object (e.g., increasing sound levels).

The present disclosure uses the terms “ear-worn device” and “computing device.” As used herein, the terms “ear-worn device” or ear-worn devices may refer to any suitable auditory device or devices including, for example, wired or wireless headphones, a hearable, Personal Sound Amplification Product (PSAP), an over-the-counter (OTC) hearing aid, a direct-to-consumer (DTC) hearing aid, a cochlear implant, a middle ear implant, a bone conduction hearing aid, etc. As used herein “computing device” may refer to any suitable computing device such as, for example, a mobile computing device (e.g., smart phone, cellular phone, table, laptop, etc.) personal computer, smart glasses, wearable computing devices, smartwatch, etc.

As used herein, “operatively coupled” may include any suitable combination of wired and/or wireless data communication. Wired data communication may include, or utilize, any suitable hardware connection such as, e.g., ethernet, peripheral component interconnect (PCI), PCI express (PCIe), optical fiber, local area network (LAN), etc. Wireless communication may include, or utilize, any suitable wireless connection such as, e.g., Wireless Fidelity (Wi-Fi), cellular network, Bluetooth, near-field communication (NFC), optical, infra-red (IR), etc. In at least one embodiment, the ear-worn device and a controller are operatively coupled.

The information provided by the various devices and sensors may allow the systems and methods described herein to determine whether the user is paying attention to where the user is moving and alert the user of an object in the environment using a probability that a collision between the user and the object may occur. The user may be alerted of the object when the probability that a collision between the user and the object may occur exceeds a threshold. The user may be alerted using any suitable technique or techniques such as, for example, a visual alert on the computing device, an auditory alert via the ear-worn device or the computing device, or a tactile alert via the ear-worn device or the computing device. If the alert is sent as sound via the ear-worn device (e.g., a beep, speech, ringing, etc.), spatial effects (e.g., time and level differences) may be applied to the alert so that it sounds as though the alert is coming from the direction that the object is located. In one embodiment, a frequency that the alert is played at (e.g., how fast a succession of beeps is played) may indicate how quickly the user is approaching the object. In one embodiment, the frequency of the alert may increase as the user gets closer to the object. In one embodiment, a sound level of the alert may increase as the distance between the user and the object decreases. Such additional information may further assist the user in avoiding the object.

A probability that the user will collide with an object may be determined using an amount of time that the user's field of attention is diverted from the direction the user is moving. In other words, the probability that the user will collide with an object may be determined using how long the user has been looking away from their path of motion. For example, if the user glances in a direction other than the way that they are moving for two seconds or less, the user may not be alerted to an object that was previously within their field of attention. However, if the user has diverted their attention from the direction of their movement for an extended period of time (e.g., 10 seconds or more), the probability that the user may collide with an object in their path may increase. Accordingly, the user may be alerted to such objects. By taking into consideration the amount of time that a user's field of attention is diverted from the direction of the user's movement, utility and value to the user may be increased.

Furthermore, a probability that the user will collide with an object may be determined using a velocity of the user or a velocity of objects in the environment. This may be helpful because the speed and direction that both the user and the objects are moving may impact the probability that the user will collide with the objects. Furthermore, it may be more probable that a user will collide with an object when the user or the object is moving quickly compared to when the user or the object is moving slowly (e.g., the probability of the user colliding with an object may be higher when they are biking at 20 miles per hour compared to walking at 3 miles per hour).

The systems and methods described herein to determine whether to alert a user of an object may allow the user to adjust parameters related to the amount of time that the user's field of attention is diverted and the speed at which the user is moving to allow the user to receive more or fewer alerts. Furthermore, the ear-worn device may use positional sensors (e.g., IMUs) determine a natural or baseline head position or the position of the ear-worn device on the user. Accordingly, the baseline head position or ear-worn device position may be accounted for in determining a user's field of attention. In other words, if the user typically walks with their head slightly down or if the hearing aids are slightly tilted up or down from a neutral position, the user may not receive an excessive number of alerts. Still further, the individual may adjust how much the user's head position (e.g., a threshold angle) is away from an object before receiving an alert. For example, one user may desire to be alerted to all objects outside of their primary focus and another user may only want to know about objects in the periphery or outside of their field of vision. In other words, the user may adjust how their personal field of attention is determined.

Additional factors that determine whether to alert the user of an object may include, for example, the user's familiarity with the environment, the time of day (which may indicate the level of fatigue that an individual may be experiencing or influence the lighting conditions), the lighting conditions (e.g., indoors, outdoors, weather related conditions such as fog, rain, or snow, etc.), the individual's collision history, the general clumsiness level of the individual, the individual's visual acuity or field of vision, the size and estimated weight of the object, the topography of the terrain, whether the individual has recently consumed substances known to impair motor function or cause dizziness (e.g., alcohol, medication, etc.), whether the individual is currently streaming media to the ear-worn device (may indicate diverted attention or affect the user's ability to hear objects), whether the object produces noise (including the level, frequency response and signal-to-noise ratio (SNR) of the noise produced), or the individual's degree of hearing loss. Consumption of substances known to impair motor function or cause dizziness may be determined using image data, the user's speech (e.g. slurring of speech), or the user's gait. The user's speech may be analyzed using the ear-worn device and the user's gate may be captured by IMUs.

The invention is defined in the claims. However, below there is provided a non-exhaustive list of non-limiting examples. Any one or more of the features of these examples may be combined with any one or more features of another example, embodiment, or aspect described herein.

Example Ex1: A system comprising:
one or more image sensors configured to sense optical information of an environment and produce image data indicative of the sensed optical information;
an ear-worn device comprising:
   a housing wearable by a user; and
   an acoustic transducer comprising at least one driver to generate sound; and
a controller comprising one or more processors and operatively coupled to the image sensor and the ear-worn device, the controller configured to:
   receive the image data;
   determine a field of attention of the user using the image data;
   detect an object outside of the field of attention using the image data;
   determine whether to alert the user of the detected object; and
   provide an alert indicative of the detected object, if it is determined to alert the user.

Example Ex2: The system as in example Ex1, wherein the controller is further configured to:
determine one or more environmental conditions using the image data; and
determine whether to alert the user of the detected object using the one or more environmental conditions.

Example Ex3: The system as in any one of the preceding examples, wherein:
the ear-worn device further comprises one or more motion sensors to sense motion of the user and provide motion data; and
controller is further configured to:
   determine the field of attention of the user using the image data and the motion data; and
   determine whether to alert the user of the detected object using the image data and the motion data.

Example Ex4: The system as in example Ex3, wherein the controller is configured to:
detect one or more movement parameters using the movement data; and
determine whether to alert the user of the detected object using the movement parameters.

Example Ex5: The system as in any of examples Ex3 or Ex4, wherein the controller is configured to:
determine a neutral head position of the user using the motion data; and
determine the field of attention using the neutral head position.

Example Ex6: The system as in any one of the preceding examples, wherein the ear-worn device further comprises an audio sensor coupled to the housing and configured to sense sound of the environment and provide sound data using the sensed sound and wherein the controller is further configured to determine whether to alert the user of the detected object using the sound data.

Example Ex7: The system as in example Ex6, wherein the controller is further configured to:
associate a portion of the sound data with the detected object; and
determine whether to alert the user of the detected object using the associated portion of the sound data.

Example Ex8: The system as in any one of the preceding examples, wherein the ear-worn device is configured to provide device data and the controller is further configured to determine whether to alert the user of the detected object using the device data.

Example Ex9: The system as in example any one of the preceding examples, wherein the system further comprises a communication device for transmitting and receiving data and wherein the controller is further configured to:
retrieve information about the environment from one or more databases using the communication device; and
determine whether to alert the user of the detected object using the retrieved information.

Example Ex10: The system as in any of the preceding examples, wherein the controller is configured to:
determine one or more time-based parameters; and
determine whether to alert the user of the detected object using the one or more time-based parameters.

Example Ex11: The system as in any of the preceding examples, wherein the system further comprises a location sensor to sense a location of the user and wherein the controller is further configured to:
determine one or more location parameters using the sensed location; and
determine whether to alert the user of the detected object using the one or more location parameters.

Example Ex12: The system as in any one of the preceding examples, wherein the controller is further configured to:
determine if the user's attention is focused on a handheld object using the image data; and
the controller is further configured to adjust the likelihood of alerting the user using the determined user's focus of attention.

Example Ex13: The system as in any of the preceding examples, wherein the system further comprises one or more physiological sensors to sense a physiological parameter of the user and wherein the controller is further configured to:
determine one or more physiological parameters using the sensed physiological data; and
determine whether to alert the user of the detected object using the one or more physiological parameters.

Example Ex14: The system as in any one of the preceding examples, wherein the system further comprises one or more gaze direction sensors to provide gaze data and wherein the controller is further configured to:
determine a gaze direction of the user using the gaze data; and
determine whether to alert the user of the detected object using the determined gaze direction.

Example Ex15: The system as in any one of the preceding examples, wherein to determine whether to alert the user of the detected object the controller is configured to:
determine a time period that the detected object has been outside of the field of attention; and
compare the time period to a threshold time period.

Example Ex16: The system as in any one of the preceding examples, wherein the controller is further configured to:
receive data of the user; and
determine whether to alert the user of the detected object using the received data of the user.

Example Ex17: The system as in any one of the preceding examples, wherein the alert is an auditory alert.

Example Ex18: The system as in any one of the preceding examples, wherein the alert includes information indicating a direction of the detected object, a proximity of the detected object, a speed of the detected object, an impending collision, or a size of the detected object.

Example Ex19: The system as in any one of the preceding examples, wherein the system further comprises a display and wherein the controller is configured to provide the alert on the display.

Example Ex20: The system as in any one of the preceding examples, wherein the controller is configured to:
determine a gaze direction of the user in response to providing the alert; and
determine whether to provide an additional alert using the determined gaze direction.

Example Ex21: The system as in any one of the preceding examples, wherein to determine whether to alert the user of the object the controller is configured to:
determine a probability that an intersection between the user and the object will occur; and
determine whether to alert the user of the object using the determined probability.

Example Ex22: The system as in any one of the preceding examples, wherein the controller is configured to alert the user if one or more object alert criteria have been met.

Example Ex23: The system as in any one of the preceding examples, wherein one or more object alert criteria are adjustable.

Example Ex24: The system as in any one of the preceding examples, wherein one or more object alert parameters are adjustable.

Example Ex25: A method comprising:
receiving image data from one or more image sensors using a controller operatively coupled to one or more image sensors and an ear-worn device of a user;
determining a field of attention of the user using the image data;
detecting an object outside of the field of attention using the image data;
determining whether to alert the user of the detected object; and
providing an alert indicative of the detected object to the user if it is determined to alert the user.

Example Ex26: The method as in example Ex25, further comprising:
determining one or more environmental conditions using the image data; and
determining whether to alert the user of the detected object using the one or more environmental conditions.

Example Ex27: The method as in any one of examples Ex25 or Ex26, further comprising:
determining the field of attention of the user using the image data and motion data provided by one or more motion sensors of an ear-worn device; and
determining whether to alert the user of the detected object using the image data and the motion data.

Example Ex28: The method as in example Ex27, further comprising:
detecting one or more movement parameters using the movement data; and
determining whether to alert the user of the detected object using the movement parameters.

Example Ex29: The method as in any of examples Ex27 or Ex28, further comprising:
determining a neutral head position of the user using the motion data; and
determining the field of attention using the neutral head position.

Example Ex30: The method as in any one of examples Ex25 to Ex29, determining whether to alert the user of the detected object using sound data provided by an audio sensor of the ear-worn device.

Example Ex31: The method as in example Ex30, further comprising:
associating a portion of the sound data with the detected object; and
determining whether to alert the user of the detected object using the associated portion of the sound data.

Example Ex32: The method as in any one of examples Ex25 to Ex31, further comprising:
receiving device data of the ear-worn device; and
determining whether to alert the user of the detected object using the device data.

Example Ex33: The method as in example any one of examples Ex25 to Ex32, further comprising:
retrieving information about the environment from one or more databases using a communication device; and
determining whether to alert the user of the detected object using the retrieved information.

Example Ex34: The method as in any of examples Ex25 to Ex33, further comprising:
determining one or more time-based parameters; and
determining whether to alert the user of the detected object using the one or more time-based parameters.

Example Ex35: The method as in any of examples Ex25 to Ex34, further comprising:
determining one or more location parameters using a sensed location; and
determining whether to alert the user of the detected object using the one or more location parameters.

Example Ex36: The method as in any one of examples Ex25 to Ex35, further comprising:
determining if the user's attention is focused on a handheld object using the image data; and
adjusting the likelihood of alerting the user using the determined user's focus of attention.

Example Ex37: The method as in any of examples Ex25 to Ex36, further comprising:
determining one or more physiological parameters using sensed physiological data; and
determining whether to alert the user of the detected object using the one or more physiological parameters.

Example Ex38: The method as in any one of examples Ex25 to Ex37, further comprising:
determining a gaze direction of the user using the gaze data; and
determining whether to alert the user of the detected object using the determined gaze direction.

Example Ex39: The method as in any one of examples Ex35 to Ex38, wherein to determine whether to alert the user of the detected object the method further comprises:
determining a time period that the detected object has been outside of the field of attention; and
comparing the time period to a threshold time period.

Example Ex40: The method as in any one of examples Ex25 to Ex39, further comprising:
receiving data of the user; and
determining whether to alert the user of the detected object using the received data of the user.

Example Ex41: The method as in any one of examples Ex25 to Ex40, wherein the alert is an auditory alert.

Example Ex42: The method as in any one of examples Ex25 to Ex41, wherein the alert includes information indicating a direction of the detected object, a proximity of the detected object, a speed of the detected object, an impending collision, or a size of the detected object.

Example Ex43: The method as in any one of examples Ex25 to Ex42, further comprising providing the alert on a display.

Example Ex44: The method as in any one of examples Ex25 to Ex43, further comprising:
determining a gaze direction of the user in response to providing the alert; and
determining whether to provide an additional alert using the determined gaze direction.

Example Ex45: The method as in any one of examples Ex25 to Ex44, further comprising:
determining a probability that an intersection between the user and the object will occur; and
determining whether to alert the user of the object using the determined probability.

Example Ex46: The method as in any one of examples Ex25 to Ex45, further comprising alerting the user if one or more object alert criteria have been met.

Example Ex47: The method as in any one of examples Ex25 to Ex46, wherein one or more object alert criteria are adjustable.

Example Ex48: The method as in any one of examples Ex25 to Ex47, wherein one or more object alert parameters are adjustable.

Example Ex49: The method or system as in any one of examples Ex1 to Ex48, wherein the alert is provided at a sound level, frequency, or duration based on one or more of ear-worn device information, environmental conditions, location parameters, movement parameters, physiological parameters, sound data, time-based parameters, or user information.

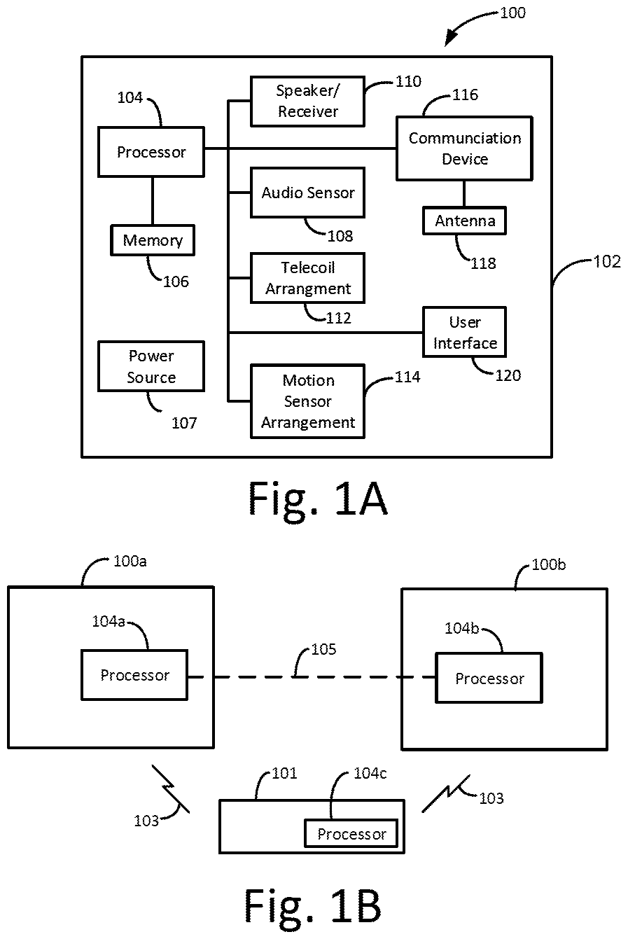

FIG. 1A is a system block diagram of an ear-worn device configured for use in, on, or about an ear of a user in accordance with any of the embodiments disclosed herein. The ear-worn device 100 shown in FIG. 1A can represent a single ear-worn device configured for monaural or single-ear operation or one of a pair of ear-worn devices configured for binaural or dual-ear operation (see e.g., FIG. 1B). The ear-worn device 100 shown in FIG. 1A includes a housing 102 within or on which various components are situated or supported.

The ear-worn device 100 includes a processor 104 operatively coupled to memory 106. The processor 104 can be implemented as one or more of a multi-core processor, a digital signal processor (DSP), a microprocessor, a programmable controller, a general-purpose computer, a special-purpose computer, a hardware controller, a software controller, a combined hardware and software device, such as a programmable logic controller, and a programmable logic device (e.g., FPGA, ASIC). The processor 104 can include or be operatively coupled to memory 106, such as RAM, SRAM, ROM, or flash memory. In some embodiments, processing can be offloaded or shared between the processor 104 and a processor of a peripheral or accessory device.

An audio sensor or microphone arrangement 108 is operatively coupled to the processor 104. The audio sensor 108 can include one or more discrete microphones or a microphone array(s) (e.g., configured for microphone array beamforming). Each of the microphones of the audio sensor 108 can be situated at different locations of the housing 102.

It is understood that the term microphone used herein can refer to a single microphone or multiple microphones unless specified otherwise. The microphones of the audio sensor 108 can be any microphone type. In some embodiments, the microphones are omnidirectional microphones. In other embodiments, the microphones are directional microphones. In further embodiments, the microphones are a combination of one or more omnidirectional microphones and one or more directional microphones. One, some, or all of the microphones can be microphones having a cardioid, hypercardioid, supercardioid, or lobar pattern, for example. One, some, or all of the microphones can be multi-directional microphones, such as bidirectional microphones. One, some, or all of the microphones can have variable directionality, allowing for real-time selection between omnidirectional and directional patterns (e.g., selecting between omni, cardioid, and shotgun patterns). In some embodiments, the polar pattern(s) of one or more microphones of the audio sensor 108 can vary depending on the frequency range (e.g., low frequencies remain in an omnidirectional pattern while high frequencies are in a directional pattern).

Depending on the ear-worn device implementation, different microphone technologies can be used. For example, the ear-worn device 100 can incorporate any of the following microphone technology types (or combination of types): MEMS (micro-electromechanical system) microphones (e.g., capacitive, piezoelectric MEMS microphones), moving coil/dynamic microphones, condenser microphones, electret microphones, ribbon microphones, crystal/ceramic microphones (e.g., piezoelectric microphones), boundary microphones, PZM (pressure zone microphone) microphones, and carbon microphones.

A telecoil arrangement 112 is operatively coupled to the processor 104, and includes one or more (e.g., 1, 2, 3, or 4) telecoils. It is understood that the term telecoil used herein can refer to a single telecoil or magnetic sensor or multiple telecoils or magnetic sensors unless specified otherwise. Also, the term telecoil can refer to an active (powered) telecoil or a passive telecoil (which only transforms received magnetic field energy). The telecoils of the telecoil arrangement 112 can be positioned within the housing 102 at different angular orientations. The ear-worn device 100 includes an acoustic transducer 110 capable of transmitting sound from the ear-worn device 100 to the user's ear drum. A power source 107 provides power for the various components of the ear-worn device 100. The power source 107 can include a rechargeable battery (e.g., lithium-ion battery), a conventional battery, and/or a supercapacitor arrangement.

As described herein, the term “acoustic transducer” may refer to a transducer that converts electrical signals into acoustic information for a user. An acoustic transducer may be configured to convert electrical signals to acoustic vibrations any suitable medium or mediums such as, for example, air, fluid, bone, etc. An acoustic transducer may include any suitable device or devices to provide acoustic information such as, for example, receivers, speakers, bone conduction transducers, magnets, cones, balanced armatures, diaphragms, coils, etc.

The ear-worn device 100 also includes a motion sensor arrangement 114. The motion sensor arrangement 114 includes one or more sensors configured to sense motion and/or a position of the user of the ear-worn device 100. The motion sensor arrangement 114 can comprise one or more of an inertial measurement unit or IMU, an accelerometer(s), a gyroscope(s), a nine-axis sensor, a magnetometer(s) (e.g., a compass), and a GPS sensor. The IMU can be of a type disclosed in commonly owned U.S. Pat. No. 9,848,273, which is incorporated herein by reference. In some embodiments, the motion sensor arrangement 114 can comprise two microphones of the ear-worn device 100 (e.g., microphones of left and right ear-worn devices 100) and software code executed by the processor 104 to serve as altimeters or barometers. The processor 104 can be configured to compare small changes in altitude/barometric pressure using microphone signals to determine orientation (e.g., angular position) of the ear-worn device 100. For example, the processor 104 can be configured to sense the angular position of the ear-worn device 100 by processing microphone signals to detect changes in altitude or barometric pressure between microphones of the audio sensor 108.

The ear-worn device 100 can incorporate an antenna 118 operatively coupled to a communication device 116, such as a high-frequency radio (e.g., a 2.4 GHz radio). The radio(s) of the communication device 116 can conform to an IEEE 802.11 (e.g., WiFi®) or Bluetooth® (e.g., BLE, Bluetooth® 4. 2, 5.0, 5.1 or later) specification, for example. It is understood that the ear-worn device 100 can employ other radios, such as a 900 MHz radio. In addition, or alternatively, the ear-worn device 100 can include a near-field magnetic induction (NFMI) sensor for effecting short-range communications (e.g., ear-to-ear communications, ear-to-kiosk communications).

The antenna 118 can be any type of antenna suitable for use with a particular ear-worn device 100. A representative list of antennas 118 include, but are not limited to, patch antennas, planar inverted-F antennas (PIFAs), inverted-F antennas (IFAs), chip antennas, dipoles, monopoles, dipoles with capacitive-hats, monopoles with capacitive-hats, folded dipoles or monopoles, meandered dipoles or monopoles, loop antennas, Yagi-Udi antennas, log-periodic antennas, and spiral antennas. Many of these types of antenna can be implemented in the form of a flexible circuit antenna. In such embodiments, the antenna 118 is directly integrated into a circuit flex, such that the antenna 118 does not need to be soldered to a circuit that includes the communication device 116 and remaining RF components.

The ear-worn device 100 also includes a user interface 120 operatively coupled to the processor 104. The user interface 120 is configured to receive an input from the user of the ear-worn device 100. The input from the user can be a touch input, a gesture input, or a voice input. The user interface 120 can include one or more of a tactile interface, a gesture interface, and a voice command interface. The tactile interface can include one or more manually actuatable switches (e.g., a push button, a toggle switch, a capacitive switch). For example, the user interface 120 can include a number of manually actuatable buttons or switches, at least one of which can be used by the user when customizing the directionality of the audio sensors 108.

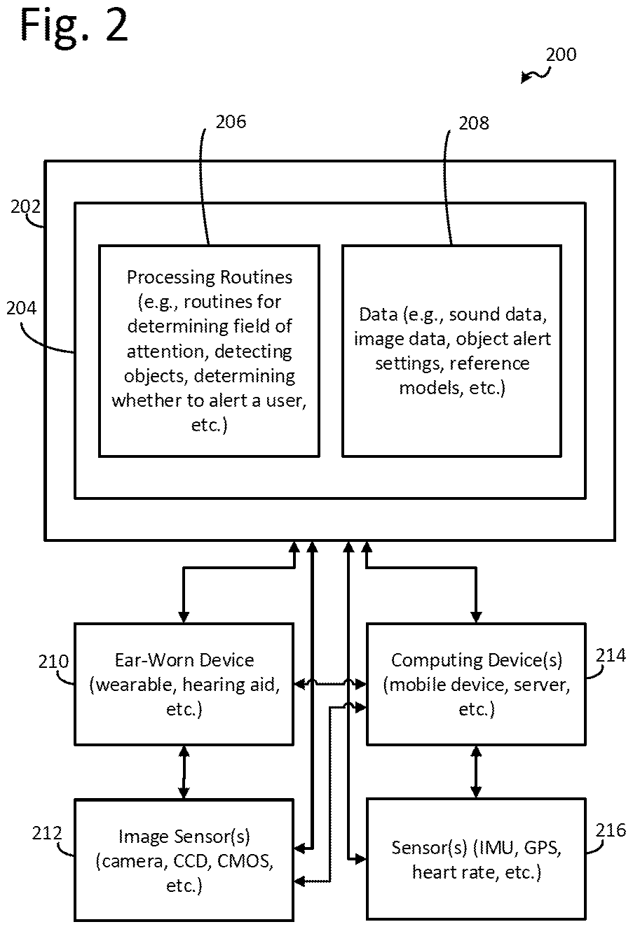

FIG. 2 is an exemplary schematic block diagram of a system 200 according to embodiments described herein. The system 200 may include a processing apparatus or processor 202 and an ear-worn device 210 (e.g., ear-worn device 100 of FIG. 1A). Generally, the ear-worn device 210 may be operatively coupled to the processing apparatus 202 and may include any one or more devices (e.g., audio sensors) configured to generate audio data from sound and provide the audio data to the processing apparatus 202. The ear-worn device 210 may include any apparatus, structure, or device configured to convert sound into sound data. For example, the ear-worn device 210 may include one or more diaphragms, crystals, spouts, application-specific integrated circuits (ASICs), membranes, sensors, charge pumps, etc.

The sound data generated by the ear-worn device 210 may be provided to the processing apparatus 202, e.g., such that the processing apparatus 202 may analyze, modify, store, and/or transmit the sound data. Further, such sound data may be provided to the processing apparatus 202 in a variety of different ways. For example, the sound data may be transferred to the processing apparatus 202 through a wired or wireless data connection between the processing apparatus 202 and the ear-worn device 210.

The system 200 may additionally include an image sensor 212 operatively coupled to the processing apparatus 202. Generally, the image sensor 212 may include any one or more devices configured to sense optical information of an environment and produce image data indicative of the sensed optical information. For example, the image sensor 212 may include one or more lenses, cameras, optical sensors, infrared sensors, charged-coupled devices (CCDs), complementary metal-oxide semiconductors (CMOS), mirrors, etc. The image data generated by the image sensor 212 may be received by the processing apparatus 202. The image data may be provided to the processing apparatus 202 in a variety of different ways. For example, the image data may be transferred to the processing apparatus 202 through a wired or wireless data connection between the processing apparatus 202 and the image sensor 212. Image data may include pictures, video, pixel data, etc.

The image sensor 212 may be an image sensor accessory (e.g., smart glasses, wearable image sensor, etc.). Additionally, the image sensor 212 may include any suitable apparatus to allow the image sensor 212 to be worn or attached to a user. Furthermore, the image sensor may include other sensors that may help classify the typical environments and activities of the user. The image sensor 212 may include one or more controllers, processors, memories, wired or wireless communication devices, etc.

The system 200 may additionally include a computing device 214 operatively coupled to the processing apparatus 202. Additionally, the computing device 214 may be operatively coupled to the ear-worn device 210, the image sensor 212, or both. Generally, the computing device 214 may include any one or more devices configured to assist in collecting or processing data such as, e.g., a mobile computing device, a laptop, a tablet, a personal digital assistant, a smart speaker system, a smart car system, a smart watch, smart ring, chest strap a TV streamer device, wireless audio streaming device, cell phone or landline streamer device, Direct Audio Input (DAI) gateway device, auxiliary audio input gateway device, telecoil/magnetic induction receiver device, ear-worn device programmer, charger, ear-worn device storage/drying box, smartphone, and wearable or implantable health monitor, etc. The computing device 214 may receive sound data from the ear-worn device 210 and image data from the image sensor 212. The computing device 214 may be configured to carry out the exemplary techniques, processes, and algorithms of determining a field of attention, detecting an object, and determining whether to alert the user.

The system 200 may additionally include one or more sensors 216 operatively coupled to the processing apparatus 202. Additionally, the one or more sensors 216 may be operatively coupled to the computing device 214. Generally, the one or more sensors 216 may include any one or more devices configured to sense physiological and geographical information about the user or to receive information about objects in the environment from the objects themselves. The one or more sensors 216 may include any suitable device to capture physiological and geographical information such as, e.g., a heart rate sensor, a temperature sensor, a Global Positioning System (GPS) sensor, an Inertial Measurement Unit (IMU), a barometric pressure sensor, an altitude sensor, acoustic sensor, telecoil/magnetic sensor, electroencephalogram (EEG) sensors, electrooptigram (EOG) sensors, electroretinogram (ERG) sensors, a radio frequency identification (RFID) reader, etc. Physiological sensors may be used to track or sense information about the user such as, e.g., heart rate, temperature, steps, head movement, body movement, skin conductance, user engagement, etc. The one or more sensors 216 may also track geographic or location information of the user. The one or more sensors 216 may be included in one or more of a wearable device, the ear-worn device 210 or the computing device 212. The one or more sensors 216 may be used to determine aspects of a user's acoustical or social environment as described in U.S. Provisional Patent Application 62/800,227, filed Feb. 1, 2019, the entire content of which is incorporated herein by reference.

Further, the processing apparatus 202 includes data storage 208. Data storage 208 allows for access to processing programs or routines 206 and one or more other types of data 148 that may be employed to carry out the exemplary techniques, processes, and algorithms of determining a field of attention of a user, detecting an object outside of the field of attention, determining whether to alert the user of the detected object, and providing an alert indicative of the detected object. For example, processing programs or routines 206 may include programs or routines for performing object recognition, image processing, field of attention determination, computational mathematics, matrix mathematics, Fourier transforms, compression algorithms, calibration algorithms, image construction algorithms, inversion algorithms, signal processing algorithms, normalizing algorithms, deconvolution algorithms, averaging algorithms, standardization algorithms, comparison algorithms, vector mathematics, analyzing sound data, analyzing ear-worn device settings, detecting defects, or any other processing required to implement one or more embodiments as described herein.

Data 148 may include, for example, sound data, image data, field of attention, environmental conditions, movement parameters, time-based parameters, location parameters, physiological parameters, user information, activities, optical components, hearing impairment settings, thresholds, ear-worn device settings, arrays, meshes, grids, variables, counters, statistical estimations of accuracy of results, results from one or more processing programs or routines employed according to the disclosure herein (e.g., determining a field of attention, detecting objects, determining whether to alert a user, etc.), or any other data that may be necessary for carrying out the one or more processes or techniques described herein.

In one or more embodiments, the system 200 may be controlled using one or more computer programs executed on programmable computers, such as computers that include, for example, processing capabilities (e.g., microcontrollers, programmable logic devices, etc.), data storage (e.g., volatile or non-volatile memory and/or storage elements), input devices, and output devices. Program code and/or logic described herein may be applied to input data to perform functionality described herein and generate desired output information. The output information may be applied as input to one or more other devices and/or processes as described herein or as would be applied in a known fashion.

The programs used to implement the processes described herein may be provided using any programmable language, e.g., a high-level procedural and/or object orientated programming language that is suitable for communicating with a computer system. Any such programs may, for example, be stored on any suitable device, e.g., a storage media, readable by a general or special purpose program, computer or a processor apparatus for configuring and operating the computer when the suitable device is read for performing the procedures described herein. In other words, at least in one embodiment, the system 200 may be controlled using a computer readable storage medium, configured with a computer program, where the storage medium so configured causes the computer to operate in a specific and predefined manner to perform functions described herein.

The processing apparatus 202 may be, for example, any fixed or mobile computer system (e.g., a personal computer or minicomputer). The exact configuration of the computing apparatus is not limiting and essentially any device capable of providing suitable computing capabilities and control capabilities (e.g., control the sound output of the system 200, the acquisition of data, such as image data, audio data, or sensor data) may be used. Additionally, the processing apparatus 202 may be incorporated in the ear-worn device 210 or in the computing device 214. Further, various peripheral devices, such as a computer display, mouse, keyboard, memory, printer, scanner, etc. are contemplated to be used in combination with the processing apparatus 202. Further, in one or more embodiments, the data 148 (e.g., image data, sound data, voice data, field of attention, collisions, sensor data, object alert settings, object alert criteria, object alert parameters, thresholds, optical components, hearing impairment settings, ear-worn device settings, an array, a mesh, a digital file, etc.) may be analyzed by a user, used by another machine that provides output based thereon, etc. As described herein, a digital file may be any medium (e.g., volatile or non-volatile memory, a CD-ROM, a punch card, magnetic recordable tape, etc.) containing digital bits (e.g., encoded in binary, trinary, etc.) that may be readable and/or writeable by processing apparatus 202 described herein. Also, as described herein, a file in user-readable format may be any representation of data (e.g., ASCII text, binary numbers, hexadecimal numbers, decimal numbers, audio, graphical) presentable on any medium (e.g., paper, a display, sound waves, etc.) readable and/or understandable by a user.

In view of the above, it will be readily apparent that the functionality as described in one or more embodiments according to the present disclosure may be implemented in any manner as would be known to one skilled in the art. As such, the computer language, the computer system, or any other software/hardware that is to be used to implement the processes described herein shall not be limiting on the scope of the systems, processes or programs (e.g., the functionality provided by such systems, processes or programs) described herein.

The techniques described in this disclosure, including those attributed to the systems, or various constituent components, may be implemented, at least in part, in hardware, software, firmware, or any combination thereof. For example, various aspects of the techniques may be implemented by the processing apparatus 202, which may use one or more processors such as, e.g., one or more microprocessors, DSPs, ASICs, FPGAs, CPLDs, microcontrollers, or any other equivalent integrated or discrete logic circuitry, as well as any combinations of such components, image processing devices, or other devices. The term “processing apparatus,” “processor,” or “processing circuitry” may generally refer to any of the foregoing logic circuitry, alone or in combination with other logic circuitry, or any other equivalent circuitry. Additionally, the use of the word “processor” may not be limited to the use of a single processor but is intended to connote that at least one processor may be used to perform the exemplary techniques and processes described herein.

Such hardware, software, and/or firmware may be implemented within the same device or within separate devices to support the various operations and functions described in this disclosure. In addition, any of the described components may be implemented together or separately as discrete but interoperable logic devices. Depiction of different features, e.g., using block diagrams, etc., is intended to highlight different functional aspects and does not necessarily imply that such features must be realized by separate hardware or software components. Rather, functionality may be performed by separate hardware or software components, or integrated within common or separate hardware or software components.

When implemented in software, the functionality ascribed to the systems, devices and techniques described in this disclosure may be embodied as instructions on a computer-readable medium such as RAM, ROM, NVRAM, EEPROM, FLASH memory, magnetic data storage media, optical data storage media, or the like. The instructions may be executed by the processing apparatus 202 to support one or more aspects of the functionality described in this disclosure.

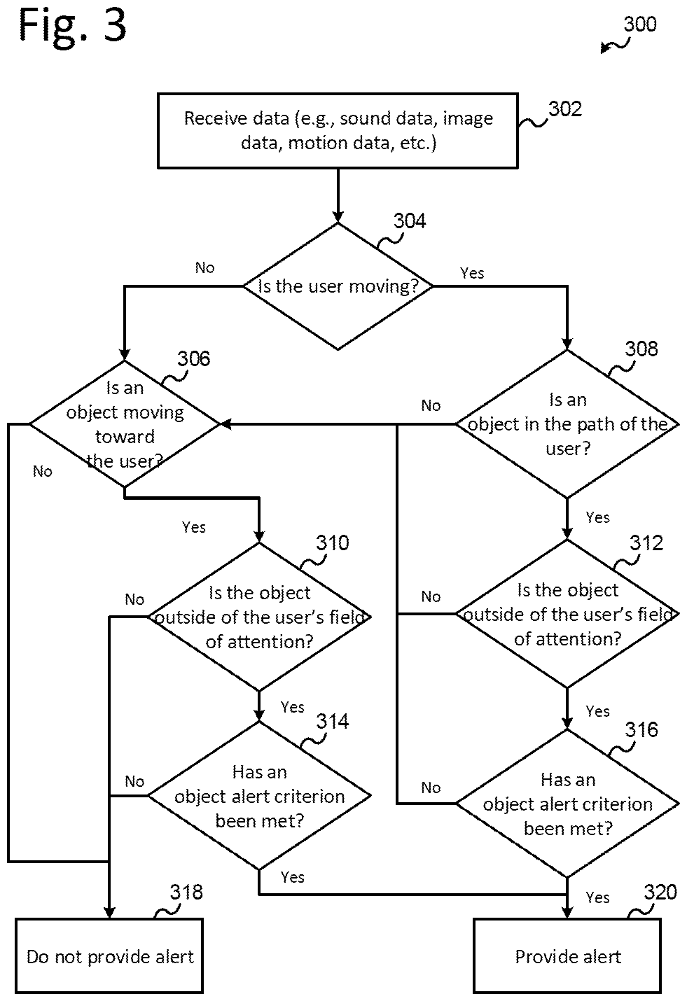

FIG. 3 illustrates a method 300 for determining whether to alert a user of an object. The method 300 can be implanted by any ear-worn devices and systems described herein (e.g., ear-worn device 100 of FIG. 1 and system 200 of FIG. 2). The method 300 involves receiving 302 data. Data may be received from one or more of, for example, an ear-worn device, sensors (e.g., movement sensors, locations sensors, image sensors, physiological sensors, etc.), a computing device, etc. Data may include, for example, sound data, image data, motion data, location data, environmental data, device data, time data, user information, etc.

The method 300 involves determining 304 if the user is moving. Determining 304 if the user is moving may include using motion data or image data. Movement parameters may be determined from the motion data. Movement parameters may include, for example, the speed of the user's movements, the direction of the user's movements, the user's gaze direction, the topography of the terrain, the user's gait, etc.

The method 300 involves determining 308 if an object is in the path of the user if the user is moving. In other words, the method 300 involves determining 308 if there is an object in the direction that the user is moving. A direction of movement of the user or a movement path of the user may be determined. Additionally, one or more objects may be identified using image data. Furthermore, it may be determined whether any identified objects are in the path of the user using the determined movement or movement path of the user and the image data.

The method 300 involves determining 312 if the object in the path of the user is outside of the user's field of attention. The user's field of attention may be determined using one or more of, for example, image data, movement data, user preferences, etc. The position of the object may be compared to the user's field of attention.

The method 300 involves determining 316 if one or more object alert criteria have been met if the object is outside of the user's field of attention. Object alert criteria may include any suitable parameters or thresholds as described herein.

The method 300 involves determining 306 if an object is moving toward the user if the user is not moving, there is no object in the path of the user, an object in the user's path is within the user's field of attention, or no object alert criteria were met by an object in the user's path and outside of the user's field of attention. Image data may be used to determine if an object is moving toward the user. An object may be tracked through a series of images or through video data to determine a velocity (e.g., direction and speed) of the object. The velocity of the object may be used to determine if the object is moving toward the user or if the object may collide with the user.

The method 300 involves determining 310 if an object moving toward the user is outside of the user's field of attention. The user's field of attention may be determined using one or more of, for example, image data, movement data, user preferences, etc. The position and trajectory of the object moving toward the user may be compared to the user's field of attention.

The method 300 involves determining 314 if one or more object alert criteria has been met if the object moving toward the user is outside of the user's field of attention. Object alert criteria may include any suitable parameters or thresholds as described herein.

The method 300 involves providing 320 an alert if one or more object alert criteria have been met. The alert may be, for example, visual, auditory, or tactile. A visual alert may be provided on a display of a computing device. Visual alerts may include an indication of the direction of the object. An auditory alert may be provided by a computing device or an ear-worn device. The auditory alert may include, for example, a beep, a series of beeps, words, chimes, etc. In one example, a frequency of the series of beeps may indicate a proximity of an object. In another example, the level of beeps may indicate a proximity of an object to the user. Furthermore, spatial effects (e.g., time and level differences) may be applied to the alert so that it sounds as though the alert is coming from the direction that the object is located. A tactile alert may be provided by a computing device or an ear-worn device. Tactile alerts may include, for example, vibration, pulse, tap, etc. In contrast, the method 300 involves not providing 318 an alert if no object alert criteria are met.

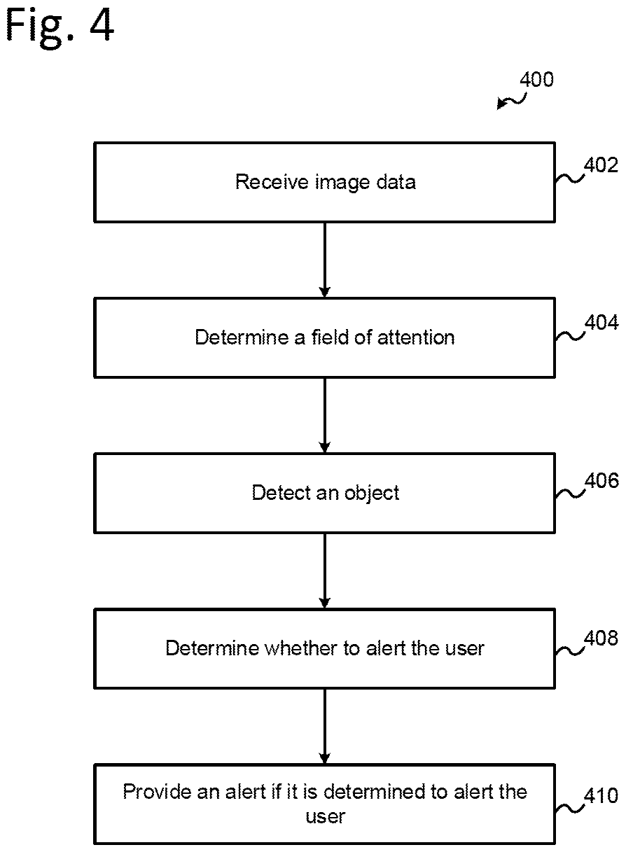

FIG. 4 illustrates a method 400 for determining whether to alert a user of an object. The method 300 can be implanted by any ear-worn devices and systems described herein (e.g., ear-worn device 100 of FIG. 1 and system 200 of FIG. 2). The method 400 involves receiving 402 image data from one or more image sensors using a controller operatively coupled to one or more image sensors and an ear-worn device of a user. The image data may be received via any suitable wired or wireless connection.

The method 400 involves determining 404 a field of attention of the user using the image data. Additionally, the user's field of attention may be determined using one or more, for example, positional sensors (e.g., IMUs), EMRE0s, etc. EMREOs may be used to determine the direction of the user's gaze direction. The user's gaze direction may be used to determine the user's field of attention.

The method 400 involves detecting 406 an object outside of the field of attention using the image data. The position of an object may be compared to the space occupied by the user's field of attention. For example, the user's field of attention may be determined to occupy a group of pixels in an image of image data. Such group of pixels may be analyzed to determine if the group of pixels includes pixels of the detected object. If the object is not included in the group of pixels it may be determined that the object is outside of the user's field of attention.

The method 400 involves determining 408 whether to alert the user of the detected object. Determining whether to alert the user of the detected object may be based on a probability that a collision between the user and an object may occur. The probability may be determined based on, for example, a velocity (e.g., speed and direction) of the user, a velocity of the object, the user's field of attention, information of the user (e.g., age, level of fitness, physical impairments, etc.), etc. Determining whether to alert the user of the detected object may be based on one or more parameters or thresholds. Parameters or thresholds may include, for example, movement, location parameters, physiological. Such parameters and thresholds may include a time-based component, for example, a time the user's gaze is diverted from an object or the time an object is outside of a user's field of attention. Such parameters and thresholds may be adjustable by the user. In one embodiment, a time period that the detected object has been outside of the field of attention may be determined and the time period may be compared to a threshold time period. The threshold time period may be at least 10 seconds, at least 9 seconds, at least 8 seconds, at least 7 seconds, at least 6 seconds, at least 5 seconds, at least 4 seconds, at least 3 seconds, at least 2 seconds, or at least 1 second. In one embodiment the threshold time period may be adjusted based on how fast the user or the object is moving. In one embodiment, the threshold time period is adjustable by the user. In one embodiment, sound data provided by an audio sensor of the ear-worn device may be used to determine whether to alert the user of the detected object.

The method 400 involves providing 410 an alert indicative of the detected object to the user if it is determined to alert the user using the controller. The alert may be, for example, visual, auditory, or tactile. A visual alert may be provided on a display of an computing device. Visual alerts may include an indication of the direction of the object. Visual alerts may include text, arrows, animations, etc. For example, an image may be displayed to a user with text stating “object approaching” and an arrow pointing in the direction of the object. An auditory alert may be provided by a computing device or an ear-worn device. The auditory alert may include, for example, a beep, a series of beeps, words, chimes, etc. In one example, a frequency of the series of beeps may indicate a proximity of an object. Furthermore, spatial effects (e.g., time and level differences) may be applied to the alert so that it sounds as though the alert is coming from the direction that the object is located. A tactile alert may be provided by a computing device or an ear-worn device. Tactile alerts may include, for example, vibration, pulse, tap, etc. In one embodiment, the alert may include information indicating a direction of the detected object, a proximity of the detected object, a speed of the detected object, an impending collision, or a size of the detected object.

Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

All references and publications cited herein are expressly incorporated herein by reference in their entirety into this disclosure, except to the extent they may directly contradict this disclosure. Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The recitation of numerical ranges by endpoints includes all numbers subsumed within that range (e.g., 1 to 5 includes 1, 1.5, 2, 2.75, 3, 3.80, 4, and 5) and any range within that range. Herein, the terms “up to” or “no greater than” a number (e.g., up to 50) includes the number (e.g., 50), and the term “no less than” a number (e.g., no less than 5) includes the number (e.g., 5).

The terms “coupled” or “connected” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality (for example, a radio chip may be operatively coupled to an antenna element to provide a radio frequency electric signal for wireless communication).

Terms related to orientation, such as “top,” “bottom,” “side,” and “end,” are used to describe relative positions of components and are not meant to limit the orientation of the embodiments contemplated. For example, an embodiment described as having a “top” and “bottom” also encompasses embodiments thereof rotated in various directions unless the content clearly dictates otherwise.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of” and the like are subsumed in “comprising,” and the like. The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

What is claimed is:

1. A system comprising:
one or more image sensors configured to sense optical information of an environment and produce image data indicative of the sensed optical information;
an ear-worn device comprising:
a housing wearable by a user; and
an acoustic transducer comprising at least one driver to generate sound; and
a controller comprising one or more processors and operatively coupled to the image sensor and the ear-worn device, the controller configured to:
receive the image data;
determine a field of attention of the user using the image data;
detect an object outside of the field of attention using the image data;
determine whether to alert the user of the detected object; and
provide an alert indicative of the detected object, if it is determined to alert the user.

2. The system of claim 1, wherein the controller is further configured to:
determine one or more environmental conditions using the image data; and
determine whether to alert the user of the detected object using the one or more environmental conditions.

3. The system of claim 1, wherein:
the ear-worn device further comprises one or more motion sensors to sense motion of the user and provide motion data; and
the controller is further configured to:
determine the field of attention of the user using the image data and the motion data; and
determine whether to alert the user of the detected object using the image data and the motion data.

4. The system of claim 3, wherein the controller is configured to:
detect one or more movement parameters using the motion data; and
determine whether to alert the user of the detected object using the movement parameters.

5. The system of claim 3, wherein the controller is configured to:
determine a neutral head position of the user using the motion data; and
determine the field of attention using the neutral head position.

6. The system of claim 1, wherein the ear-worn device further comprises an audio sensor coupled to the housing and configured to sense sound of the environment and provide sound data using the sensed sound and wherein the controller is further configured to determine whether to alert the user of the detected object using the sound data.

7. The system of claim 6, wherein the controller is further configured to:
associate a portion of the sound data with the detected object; and
determine whether to alert the user of the detected object using the associated portion of the sound data.

8. The system of claim 1, wherein the system further comprises a communication device for transmitting and receiving data and wherein the controller is further configured to:
retrieve information about the environment from one or more databases using the communication device; and
determine whether to alert the user of the detected object using the retrieved information.

9. The system of claim 1, wherein the system further comprises a location sensor to sense a location of the user and wherein the controller is further configured to:
determine one or more location parameters using the sensed location; and
determine whether to alert the user of the detected object using the one or more location parameters.

10. The system of claim 1, wherein the controller is further configured to:
determine if the user's attention is focused on a handheld object using the image data; and
the controller is further configured to adjust the likelihood of alerting the user using the determined user's focus of attention.

11. The system of claim 1, wherein the system further comprises one or more physiological sensors to sense a physiological parameter of the user and wherein the controller is further configured to:
determine one or more physiological parameters using the sensed physiological data; and
determine whether to alert the user of the detected object using the one or more physiological parameters.

12. The system of claim 1, wherein the system further comprises one or more gaze direction sensors to provide gaze data and wherein the controller is further configured to:
determine a gaze direction of the user using the gaze data; and
determine whether to alert the user of the detected object using the determined gaze direction.

13. The system of claim 1, wherein to determine whether to alert the user of the detected object the controller is configured to:
determine a time period that the detected object has been outside of the field of attention; and
compare the time period to a threshold time period.

14. The system of claim 1, wherein the alert includes information indicating a direction of the detected object, a proximity of the detected object, a speed of the detected object, an impending collision, or a size of the detected object.

15. The system of claim 1, wherein the controller is configured to:
determine a gaze direction of the user in response to providing the alert; and
determine whether to provide an additional alert using the determined gaze direction.

16. The system of claim 1, wherein to determine whether to alert the user of the object the controller is configured to:
determine a probability that an intersection between the user and the object will occur; and
determine whether to alert the user of the object using the determined probability.

17. The system of claim 1, wherein:
the controller is configured to alert the user if one or more object alert criteria have been met; and
the one or more object alert criteria are adjustable.

18. A method comprising:
receiving image data from one or more image sensors using a controller operatively coupled to one or more image sensors and an ear-worn device of a user;
determining a field of attention of the user using the image data;
detecting an object outside of the field of attention using the image data;
determining whether to alert the user of the detected object; and
providing an alert indicative of the detected object to the user if it is determined to alert the user.

19. The method of claim 18, further comprising:
determining one or more environmental conditions using the image data; and
determining whether to alert the user of the detected object using the one or more environmental conditions.

20. The method of claim 18, further comprising:
determining the field of attention of the user using the image data and motion data provided by one or more motion sensors of an ear-worn device; and
determining whether to alert the user of the detected object using the image data and the motion data.

21. The method of claim 20, further comprising:
detecting one or more movement parameters using the motion data; and
determining whether to alert the user of the detected object using the movement parameters.

22. The method of claim 20, further comprising:
determining a neutral head position of the user using the motion data; and
determining the field of attention using the neutral head position.

23. The method of claim 18, further comprising determining whether to alert the user of the detected object using sound data provided by an audio sensor of the ear-worn device.

24. The method of claim 23, further comprising:
associating a portion of the sound data with the detected object; and
determining whether to alert the user of the detected object using the associated portion of the sound data.

25. The method of claim 18, further comprising:
determining one or more physiological parameters using sensed physiological data; and
determining whether to alert the user of the detected object using the one or more physiological parameters.

26. The method of claim 18, further comprising:
determining a gaze direction of the user using the gaze data; and
determining whether to alert the user of the detected object using the determined gaze direction.

27. The method of claim 18, wherein to determine whether to alert the user of the detected object the method further comprises:
determining a time period that the detected object has been outside of the field of attention; and
comparing the time period to a threshold time period.

28. The method of claim 18, wherein the alert is provided at a sound level, frequency, or duration based on one or more of ear-worn device information, environmental conditions, location parameters, movement parameters, physiological parameters, sound data, time-based parameters, or user information.
